(19) United States
(12) Patent Application Publication
(10) Pub. No.: US 2009/0011223 A1
(43) Pub. Date: Jan. 8, 2009

(54) Polyimide Film and Method for Production Thereof

(76) Inventors: Hisayasu Kaneshiro, Kyoto (JP); Takashi Kikuchi, Shiga (JP); Shogo Fujimoto, Shiga (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/087,935

(22) PCT Filed: Jan. 4, 2007
(86) PCT No.: PCT/JP2007/050007

§ 371 Date: Jul. 16, 2008

(30) Foreign Application Priority Data
Jan. 20, 2006 (JP) 2006-011962
Mar. 16, 2006 (JP) 2006-072135

(51) Int. Cl. B32B 27/20

(52) U.S. Cl. 428/327; 524/879

(57) ABSTRACT

Disclosed is a polyimide film which is free from coarse particles caused by aggregation of a filler, therefore, can avoid abnormal electrical discharge during a discharge treatment, repelling during application of an adhesive, and the like. Also disclosed is a method for production of the polyimide film. The method for production of the polyimide film is characterized by using an organic solvent solution containing an inorganic filling material and a first polyamic acid, wherein the organic solvent solution containing the first polyamic acid is prepared by a process comprising the steps of: 1) preparing a dispersion solution which contains the inorganic filling material and a second polyamic acid and has a viscosity of 50 to 500 poises; 2) filtering the dispersion solution; 3) mixing a prepolymer solution containing the first polyamic acid in the process of being polymerized and having a viscosity of 100 poises or lower with the filtered dispersion solution; and 4) increasing the viscosity of the mixed solution to a level ranging from 1000 to 6000 poises.

### TECHNICAL FIELD

The present invention relates to a polyimide film that is suitably used for an electrical material such as a flexible printed board, a COF (Chip On Film) base film, and a TAB (Tape Automated Bonding) tape, and a method for production thereof.

### BACKGROUND ART

Recently, electronic products have been improved to be lighter in weight, smaller in size, and higher in density, thereby resulting in an increase in the demand for various types of printed boards, especially, the demand for a flexible laminate (may be referred to as a Flexible Printed Circuit board [FPC]). The flexible laminate has such a structure that a circuit made of a metal foil is formed on an insulating film. When producing the flexible laminate, there are some methods for attaching the metal foil to the insulating film, such as a method using an adhesive and a method for attaching a metallic layer directly by sputtering or the like.

In the insulating film used in the flexible laminate, small quantities of inorganic particles are added as an antiblocking material. However, in case where the inorganic particles are not dispersed adequately in the film, a large protrusion is formed, thereby causing the film to repel the adhesive or a pinhole to form when sputtering. Further, it has been found that the formation of the protrusion induces abnormal electrical discharge during a surface treatment by discharge, and therefore a surface roughness of the insulating film increases. Also, even if the inorganic particles are dispersed adequately at first, an inappropriate method for adding the inorganic particles to polyamic acids causes the inorganic particles to re-aggregate or precipitate due to the addition.

Further, when the large protrusion having a size of 5 to 10 μm or more exists in the film, the protrusion is recognized as a foreign substance in an appearance check of the FPC, thereby decreasing the yield. A scratch of the film caused by the protrusion may also decrease the yield.

There has been an approach to improve an electrical conductivity and a mechanical strength by using a large amount of filling material (see Patent Citation 1). The invention in Patent Citation 1 is designed mainly to enhance an adhesion between the filling material and a matrix resin, therefore there are such problems that a small quantity of the polyamic acid exists in a slurry, or that re-aggregation tends to occur due to usage of various types of the polyamic acid.

Patent Citation 2 discloses a method for forming a film by mixing a dispersion solution of a filler and a polyamic acid solution having a high viscosity with a polyamic acid solution having a low viscosity. However, the method requires sophisticated know-how for mixing the solution having the high viscosity with the dispersion solution having the low viscosity, and a technique for preventing the filler from precipitating in the dispersion solution.

### [Patent Citation 1]

### Japanese Unexamined Patent Application Publication No.

### [Patent Citation 2]

### Japanese Unexamined Patent Application Publication No.

### DISCLOSURE OF INVENTION

### Problems to be Solved by the Invention

The present invention has been accomplished in view of the problems above, and an object of the present invention is to provide a polyimide film which is free from coarse particles caused by aggregation of a filler and, therefore, can avoid abnormal electrical discharge during a discharge treatment, repelling during application of an adhesive, and the like. An object of the present invention is also to provide a method for production of the polyimide film.

### Means for Solving Problems

As a result of diligent studies on the objects, the inventors of the present invention have found that the polyimide film having the highly-dispersed filler can be obtained by improving a process for dispersing the filler and a process for adding to a varnish. Based on this finding, the inventors of the present invention accomplished the present invention.

The present invention relates to a polyimide film that includes 0.01 to 0.30 wt % of an inorganic filling material, and is substantially free from an inorganic filling material-aggregated substance having a size of more than 10 μm.

A preferable embodiment relates to the polyimide film in which an aggregated substance of the inorganic filling material, which has a size of more than 5 μm, does not exist substantially.

A preferable embodiment relates to any of the polyimide film above, wherein a primary particle of the inorganic filling material is not less than 0.1 μm and not more than 5.0 μm in maximum diameter.

A preferable embodiment relates to any of the polyimide film above, wherein a primary particle of the inorganic filling material is not less than 0.1 μm and not more than 3.0 μm in maximum diameter.

Moreover, the present invention relates to a method for production of any of the polyimide film above, the method characterized by using an organic solvent solution containing an inorganic filling material and a first polyamic acid, wherein the organic solvent solution containing the first polyamic acid is prepared by a process comprising: 1) preparing a dispersion solution which comprises the inorganic filling material and a second polyamic acid and has a viscosity of 50 to 500 poises; 2) filtering the dispersion solution; 3) mixing the filtered dispersion solution with a prepolymer solution comprising the first polyamic acid in the process of being polymerized and having a viscosity of 100 poises or lower; and 4) increasing the viscosity of the mixed solution to a level ranging from 1000 to 6000 poises.

A preferable embodiment relates to the method for production of the polyimide film, wherein the dispersion solution is filtered through a filter having a filtration rating of 10 μm or less in the step 2).

A preferable embodiment relates to any of the described method for production of the polyimide film, wherein the prepolymer solution used in 3) is filtered through a filter having a filtration rating of 5 μm or less.

A preferable embodiment relates to any of the described method for production of the polyimide film, wherein the first polyamic acid is identical to the second polyamic acid.

### EFFECT OF THE INVENTION

The present invention can provide a polyimide film that is free from an abnormal protrusion or a defect caused by aggregation of a filler, therefore is suitably used in a high-density mounting circuit board such as a COF, a TAB, and a FPC. The present invention also can provide a method for production of the polyimide film.

### BEST MODE FOR CARRYING OUT THE INVENTION

One embodiment of the present invention is described below.

The polyimide film according to the present invention can be produced by using a polyamic acid as a precursor. The polyamic acid can be produced by any known method. Normally, in order to obtain the polyamic acid, an aromatic acid dianhydride and an aromatic diamine, substantially equimolar amounts to each other, are dissolved in an organic solvent, and then the organic solvent solution of the polyamic acid is stirred under a controlled temperature until polymerization of the acid dianhydride and the diamine is accomplished. The polyamic acid solution is obtained with a concentration of 5 to 35 wt %, more preferably 10 to 30 wt %. When the concentration of the polyamic acid solution is within the range, it becomes possible to obtain a suitable molecular weight of the polyamic acid and solution viscosity.

The polyamic acid can be polymerized by any known method or a combination thereof. The method for polymerizing the polyamic acid is characterized by an order of addition of a monomer. By controlling the order, physical properties of the polyimide can be controlled. Therefore, according to the present invention, any method for adding the monomer can be used in the polymerization of the polyamic acid. Typical methods for polymerization are described below:

1) Dissolving an aromatic diamine in an organic polar solvent; and reacting with an aromatic tetracarboxylic dianhydride of equimolar amount to the aromatic diamine,

2) Reacting, in an organic polar solvent, an aromatic tetracarboxylic dianhydride with an aromatic diamine compound that is less than the aromatic tetracarboxylic dianhydride in a molar amount, thereby obtaining a prepolymer that has acid anhydride groups at both ends; and thereafter adding the aromatic diamine compound so as to make up a substantially equimolar amount of the aromatic diamine compound in overall process with respect to of the aromatic tetracarboxylic dianhydride.

3) Reacting, in an organic polar solvent, an aromatic tetracarboxylic dianhydride with an aromatic diamine compound that is greater than the aromatic tetracarboxylic dianhydride in molar amount thereby obtaining a prepolymer that has amino groups at both ends; and adding the aromatic diamine compound thereto; and thereafter adding the aromatic tetracarboxylic dianhydride so as to make up an substantially equimolar amount of the aromatic tetracarboxylic dianhydride in the overall process with respect to the aromatic diamine compound.

4) Dissolving and/or dispersing an aromatic tetracarboxylic dianhydride in an organic polar solvent; and adding an aromatic diamine compound of an equimolar amount to the aromatic tetracarboxylic dianhydride.

5) Reacting, in an organic polar solvent, an aromatic tetracarboxylic dianhydride and an aromatic diamine compound of equimolar amounts to each other.

The methods can be carried out independently or partly in combination.

The polyamic acid according to the present invention is not limited in terms of its structure, and is designed accordingly by selecting the monomer in order to fulfill the physical properties of the eventual polyimide. Examples of the monomer are described below.

Examples of the diamine, which is preferably used as a main component, encompass: 4,4′-diaminodiphenylpropane, 4,4′-diaminodiphenylmethane, 4,4′-diaminophenylsulfide, 3,3′-diaminodiphenylsulfone, 4,4′-diaminodiphenylsulfone, 4,4′-oxydianiline, 3,3′-oxydianiline, 3,4′-oxydianiline, 4,4′-diaminodiphenyldiethylsilane, 4,4′-diaminodiphenylsilane, 4,4′-diaminodiphenylethylphosphineoxide, 4,4′-diaminodiphenyl-N-methylamine, 4,4′-diaminodiphenyl-N-phenylamine, 1,4-diaminobenzene(p-phenylenediamine), bis{4-(4-aminophenoxy)phenyl}sulfone, bis{4-(3-aminophenoxy)phenyl}sulfone, 4,4′-bis(4-aminophenoxy)biphenyl, 4,4′-bis(3-aminophenoxy)biphenyl, 1,3-bis(3-aminophenoxy)benzene, 1,3-bis(4-aminophenoxy)benzene, 1,3-bis(4-aminophenoxy)benzene, 1,3-bis(3-aminophenoxy)benzene, 3,3′-diaminobenzophenone, 4,4′-diaminobenzophenone, 2,2-bis(4-aminophenoxyphenyl) propane, p-phenylenediamine and derivatives thereof, benzidine and derivatives thereof. These compounds may be used solely or in combination at an arbitrary ratio.

Examples of the tetracarboxylic dianhydride encompass: pyromellitic dianhydride (hereinafter may be referred to as “PMDA”), 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis(trimellitic monoester acid anhydride), ethylenebis(trimellitic monoester acid anhydride), bisphenol Abis(trimellitic monoester acid anhydride), and similar compounds. These compounds may be used solely or in combination at an arbitrary ratio.

According to the production methods of the present invention, the polyamic acid solution in process of the polymerization (hereinafter referred to as “prepolymer solution”) is preferably filtered through a filter having a filtration rating of 5 μm or less, more preferably 3 μm or less, particular preferably 2 μm or less. It should be noted that the wording “filtration rating of 5 μm”, for example, means that the filter filters out 95 wt % or more of particles that have a size of 5 μm or more. The prepolymer solution at the stage of filtration preferably has a viscosity of 100 poises or lower, more preferably 50 poises or lower, particular preferably 30 poises or lower. When the filtration rating is greater than the range, a coarse protrusion can be formed in the obtained film due to a foreign substance in a material, thereby resulting in the abnormal electrical discharge or the repelling of the adhesive. Also, when the viscosity of the prepolymer solution is greater than the range, a pressure exerted by the filtration may become too high to carry out the high-accuracy filtration associated with high productivity. The viscosity according to the present invention, unless otherwise noted, is indicated in a value measured by E Type Viscometer RE550U (TOKI SANGYO CO., LTD.) at 23° C.

According to the production methods of the present invention, the polymerization is accomplished after adding a dispersion solution including an inorganic filling material described below to the prepolymer solution, thereby obtaining the polyamic acid solution having a viscosity of a level ranging from 1000 to 6000 poises, preferably from 1500 to 5000 poises. When the final viscosity of the solution is within the range, it becomes easy to keep high film-forming properties and productivity.

A solvent for synthesizing a polyimide precursor (hereinafter may be referred to as “polyamic acid”) has only to be capable of dissolving the polyamic acid. An amide solvent such as N,N-dimethylformamide (hereinafter may be referred to as “DMF”), N,N-dimethylacetamide, or N-methyl-2-pyrolidone is suitably used. In particular, N,N-dimethylformamide and N,N-dimethylacetamide are preferable.

The polyimide film according to the present invention includes the inorganic filling material for purposes of improving slidability. The inorganic filling material can be any material other than one having electrical conductivity. For example, silica, titanium oxide, alumina, silicon nitride, boron nitride, calcium hydrogenphosphate, calcium phosphate, and mica are preferably used. Also, an additive or a surface treatment may be applied accordingly in order to improve dispersibility of the inorganic filling material in the film.

A maximum diameter of a primary particle of the inorganic filling material usable in the present invention is preferably 0.1 μm or more and 5.0 μm or less, more preferably 0.1 μm or more and 3.0 μm or less, particular preferably 0.1 μm or more and 2.0 μm or less. When the diameter is greater than the range, the repelling of the adhesive tends to occur easily when applying the adhesive to the film. In addition, the inorganic filling material includes particles of less than 1 μm in diameter by 20 wt % or less, more preferably 10 wt % or less. When the fraction of the particles of less than 1 μm in diameter increase in weight, the slidabilities cannot be easily attained, thereby causing an unnecessary addition of the inorganic filling material.

According to the present invention, the dispersion solution including the inorganic filling material can preferably be prepared as below.

1) The inorganic filling material is dispersed in a solvent that is preferably identical to the solvent used for the polymerization of the polyamic acid. The dispersion can be carried out by using any known method such as a normal stirrer, a ultrasonic wave, or a homogenizer. However, it is preferable that the particle of the inorganic filling material is not crushed due to the method when dispersing. Advanced crush of the particle tends to cause deterioration of the slidabilities of the film.
2) To the solution obtained in 1), a second polyamic acid solution having a viscosity of 1000 to 6000 poises is added gradually, thereby obtaining a dispersion solution uniformly-dissolved with a viscosity of 50 to 500 poises, preferably 50 to 400 poises. When the viscosity of the dispersion solution is less than the range, re-aggregation of the particles of the inorganic filling material is more likely to occur when adding the dispersion solution to the prepolymer solution. Also, the solution cannot be retained stably, and the particles of the inorganic filling material are more likely to precipitate. On the other hand, when the viscosity of the dispersion solution is higher than the range, the filtration in a following process cannot be carried out with accuracy.
3) The dispersion solution is filtered through a filter having a filtration rating of preferably 10 μm or less, more preferably 5 μm or less, thereby obtaining a dispersion solution of the inorganic filling material, which finally includes 2 to 20 wt %, preferably 5 to 15 wt % of the inorganic filling material. By filtering the dispersion solution in this process, it becomes possible to remove coarse particles that are mixed with the filling material produced by the crush and aggregated substances caused by inadequate dispersion. When the amount of the inorganic filling material in the solution is greater than the range, the precipitation of the particles is more likely to occur, and it becomes difficult to carry out a high-accuracy filtration. When the amount of the inorganic filling materials in the solution is less than the range, there is no critical problem to proceed to further processes, however, a large amount of the dispersion solution comes to be required.

Next, the filtered dispersion solution including the inorganic filling material is mixed with the prepolymer solution having a viscosity of 100 poises or lower, which is in process of polymerization of the first polyamic acid. Then, the polymerization is accomplished, thereby obtaining a polyamic acid solution having a viscosity of 1000 to 6000 poises, preferably 1500 to 5000 poises.

When mixing the filtered dispersion solution including the inorganic filling material and the prepolymer solution, as described above, the mixture is adjusted accordingly to obtain the polyimide film, which is produced with the polyamic acid solution described above, including the inorganic filling material at preferably 0.01 to 0.30 wt %, more preferably 0.05 to 0.02 wt %. When the amount of the inorganic filling material in the film is less than 0.01 wt %, the slidabilities tend to be poor. On the other hand, when the amount of the inorganic filling material in the film is more than 30 wt %, mechanical properties such as elongation characteristic tend to be poor.

According to the present invention, it is preferable that the second polyamic acid that is added to the dispersion solution including the inorganic filling material is identical to the first polyamic acid in the prepolymer solution that is to be mixed with the dispersion solution, so as to preserve the property.

A method for producing the polyimide film with these polyamic acid solutions can be carried out by using a known method.

When producing the polyimide film with the polyamic acid solutions, it is preferable to heat the film at final temperature of 400 to 650° C. for 5 to 400 seconds. When the temperature is over the range, or the time is longer, the film may be deteriorated by heat, thereby causing several problems. When the temperature is below the range, or the time is shorter, a predetermined effect may not be expressed.

Further, in order to reduce an internal stress remaining in the film, a heating treatment can be carried out under a minimum pressure required to convey the film. The heating treatment can be carried out in the process of the film production, or separately as another process. The heating condition depends on film characteristic or a heating device. Normally, it is possible to reduce the internal stress by heating at a temperature in a range of 200 to 500° C., more preferably in a range of 250 to 500° C., particular preferably in a range of 300 to 450° C., for 1 to 300 seconds, more preferably 2 to 250 seconds, particular preferably 5 to 200 seconds.

According to the present invention, it is possible to obtain such a polyimide film that 0.01 to 0.30 wt % of the inorganic filling material is included, and an aggregated inorganic filling material having a size of more than 10 μm, further more than 5 μm, does not exist substantially. For example, the present invention makes it possible to prevent the inorganic filling material from re-aggregating after the dispersion and the filtration, thereby obtaining such a film that the aggregated inorganic filling material having a size of more than 10 μm does not exist substantially. It should be noted that, according to the present invention, the wording “do not exist substantially” means that the aggregated substance cannot be found in a test piece (10×30 cm) of the film by microscopic observation.

### EXAMPLES

Examples of the present invention are described below. However, the present invention is not limited to these examples.

(Assessment of Repelling of the Adhesive)

In a glass flask of a 2000 ml volume, 780 g of DMF and 115.6 mg of 2,2-bis[4-(4-amiophenoxy)phenyl]propane (BAPP) were added, and thereafter 78.7 g of 3,3′,4,4′-biphenyltetracarboxylic dianhydride (BPDA) was added gradually with stirring under nitrogen atmosphere. Then, 3.8 g of ethylenebis (trimellitic monoester acid anhydride) (TMEG) was added, and was stirred thereafter for 30 minutes in an ice bath. Such a solution that 2.0 g of TMEG is dissolved in 20 g of DMF is prepared separately. With giving an attention to the viscosity, the solution was added to and mixed with the reacting solution above until its viscosity came to 3000 poises. The solution was diluted with DMF until a solid concentration became 10 wt %, thereby obtaining the polyamic acid solution. The polyamic acid solution was applied to both surfaces of the polyimide film obtained in each example and comparative example, so that a final thickness of one surface of a thermoplastic polyimide layer (adhesive layer) became 4 μm. The film was heated thereafter at 140° C. for 1 minute. The number of positions at which repelling occurred was counted in an area of 30 cm×1 m in the film.

(The Number of the Aggregates in the Film)

Three pieces of sample having a size of 10 (in width direction)×30 cm (in longer direction) were cut out from a center part of the film in width direction. The samples were observed by an optical microscope in order to count the number of the aggregates (aggregated particle) having a size of 5 to 10 μm, and 10 μm or more.

### Reference Example 1

4,4′-oxydianiline (ODA) was dissolved in N,N-dimethylformamide (DMF) that was cooled to 10° C. Then, pyromellitic dianhydride (PMDA) was added to be 96 mol % of ODA. After stirring for 30 minutes, the prepolymer solution having a viscosity of 15 poises was obtained. The prepolymer solution was filtered through a filter having a filtration rating of 3 μm, and then transferred to an other container.

To the prepolymer solution, a DMF solution including 7 wt % of PMDA (filtered with a filter having a filtration rating of 1 μm), which was prepared separately, was added until the viscosity of the mixed solution became approximately 1800 poises. Then, the solution was stirred uniformly for 1 hour. The obtained polyamic acid solution had a viscosity of 2500 poises at 23° C., and a solid concentration of the solution was 18.5 wt %. (ODA/PMDA=1/1 (molar ratio))

### Example 1

Two hundred seventy eight grams of calcium hydrogen phosphate (a maximum diameter of a primary particle is 3 μm, including 8 wt % of particles having a size of less than 1 μm) was added to 1222 g of DMF, and then stirred at 8000 rpm. Added to this solution was 500 g of the polyamic acid solution having a viscosity of 2500 poises, which was obtained in Reference example 1. After stirring at 8000 rpm for 30 minutes, 1500 g of the polyamic acid solution was further added, and then stirred at 200 rpm. Consequently, a dispersion solution having a viscosity of 60 poises was obtained.

After filtering through a filter having a filtration rating of 5 μm, the dispersion solution was added to the prepolymer solution (polymerization solution in process of polymerization of the polyamic acid) obtained in Reference example 1 until a concentration of the filling material became 0.01 wt %, and then stirred for 30 minutes. Then, the PMDA solution was added in the same way with Reference example 1, thereby obtaining a polyamic acid solution having a viscosity of 2800 poises at 23° C.

Added to this solution was a curing agent including acetic anhydride/isoquinoline/DMF (580:70:150 by weight) to get the curing agent become 40 wt % of the polyamic acid solution. The obtained solution was stirred continuously with a mixer, and extruded via a T die so as to be cast onto a stainless-steel endless belt, which runs at a velocity of 12 m/min, provided 25 mm under the die. The obtained resin film was dried and imidized continuously at 130° C. for 100 seconds, 300° C. for 20 seconds, 450° C. for 20 seconds, and 500° C. for 20 seconds, thereby obtaining a polyimide film having a thickness of 25 μm. This polyimide film included 0.15 wt % of the inorganic filling material. Properties of this polyimide film are shown in Table 1.

### Example 2

A polyimide film was obtained in the same way as Example 1, however, calcium hydrogenphosphate used in Example 2 was such that a maximum diameter of a primary particle is 4 μm, and 7 wt % of particles having a size of less than 1 μm is included. This polyimide film included 0.15 wt % of the inorganic filling material. Properties of this polyimide film are shown in Table 1.

### Comparative Example 1

A polyimide film was obtained in the same way as Example 1, except that the polyamic acid solution was not added when preparing the dispersion solution. Properties of this polyimide film are shown in Table 1.

### Comparative Example 2

A polyimide film was obtained in the same way as Example 1, except that the dispersion solution was not filtered. Properties of this polyimide film are shown in Table 1.

### Comparative Example 3

A polyimide film was obtained in the same way as Example 1, except that the polyamic acid solution having a viscosity of 2500 poises, which was obtained in Reference example 1, was added to the dispersion solution instead of adding the dispersion solution to the prepolymer solution, when obtaining the polyamic acid solution including the filler. In addition, the time for stirring the polyamic acid solution was changed to 1 hour. Properties of this polyimide film are shown in Table 1.

TABLE 1

| | | | COM. | COM. | COM. |
|---|---|---|---|---|---|
| | EX. 1 | EX. 2 | EX. 1 | EX. 2 | EX. 3 |
| REPELLING | NO | NO | 5 | 15 | 10 |
| | REPEL- | REPEL- | | | |
| | LING | LING | | | |
| THE NUMBER | 0 | 2 | 30 | 50 | 25 |
| OF PARTICLE | | | | | |
| AGGREGATES | | | | | |
| (5~10 μm) | | | | | |
| THE NUMBER | 0 | 0 | 10 | 25 | 5 |
| OF PARTICLE | | | | | |
| AGGREGATES | | | | | |
| (>10 μm) | | | | | |

Abbreviation:
EX. stands for EXAMPLE
COM. EX. stands for COMPARATIVE EXAMPLE

According to the present invention, it is possible to obtain the polyimide film that has no coarse protrusion occurred by the filler aggregation.

1. A polyimide film that comprises 0.01 to 0.30 wt % of an inorganic filling material, and is substantially free from aggregates of the inorganic filling material, which have a size of more than 10 μm.

2. The polyimide film according to claim 1, wherein:
aggregates of the inorganic filling material, which have a size of more than 5 μm, do not exist substantially.

3. The polyimide film according to claim 1, wherein:
a primary particle of the inorganic filling material is 0.1 μm or more and 5.0 μm or less in maximum diameter.

4. The polyimide film according to claim 1, wherein:
a primary particle of the inorganic filling material is 0.1 μm or more and 3.0 μm or less in maximum diameter.

5. A method for production of a polyimide film as set forth in claim 1,
the method comprising preparing the polyimide film from an organic solvent solution comprising an inorganic filling material and a first polyamic acid,
the organic solvent solution comprising the first polyamic acid being prepared by the steps of:
1) preparing a dispersion solution which comprises the inorganic filling material and a second polyamic acid and has a viscosity of 50 to 500 poises;
2) filtering the dispersion solution;
3) mixing the filtered dispersion solution with a prepolymer solution in which polymerization of the first polyamic acid is being taking place and which has a viscosity of 100 poises or lower; and
4) increasing the viscosity of the mixed solution to a level ranging from 1000 to 6000 poises.

6. The method for production of the polyimide film according to claim 5, wherein:
the step 2) comprises filtering the dispersion solution through a filter having a filtration rating of 10 μm or less.

7. The method for production of the polyimide film according to claim 5, wherein:
the prepolymer solution used in the step 3) has been filtered through a filter having a filtration rating of 5 μm or less.

8. The method for production of the polyimide film according to claim 5, wherein:
the first polyamic acid is identical to the second polyamic acid.

9. The polyimide film according to claim 2, wherein:
a primary particle of the inorganic filling material is 0.1 μm or more and 5.0 μm or less in maximum diameter.

10. The polyimide film according to claim 2, wherein:
a primary particle of the inorganic filling material is 0.1 μm or more and 3.0 μm or less in maximum diameter.

11. The method for production of the polyimide film according to claim 6, wherein:
the prepolymer solution used in the step 3) has been filtered through a filter having a filtration rating of 5 μm or less.
